(19) United States
(12) Patent Application Publication
(10) Pub. No.: US 2013/0290718 A1
(43) Pub. Date: Oct. 31, 2013

(54) MOBILE STORAGE DEVICE AND THE DATA PROCESSING SYSTEM AND METHOD BASED THEREON

(71) Applicants: Xiao Zhuang, Shanghai (CN); Zhijun Lu, Shanghai (CN); Shuo He, Shanghai (CN); Hongwen Meng, Shanghai (CN); Peng Ou, Shanghai (CN)

(72) Inventors: Xiao Zhuang, Shanghai (CN); Zhijun Lu, Shanghai (CN); Shuo He, Shanghai (CN); Hongwen Meng, Shanghai (CN); Peng Ou, Shanghai (CN)

(73) Assignee: CHINA UNIONPAY CO., LTD., Shanghai (CN)

(21) Appl. No.: 13/881,721

(22) PCT Filed: Oct. 26, 2011
(86) PCT No.: PCT/CN2011/001788

§ 371 Date: Jul. 12, 2013

(30) Foreign Application Priority Data
Oct. 28, 2010 (CN) 201010523982.4

(51) Int. Cl. H04L 29/06

(52) U.S. Cl. CPC H04L 63/0428
USPC 713/168

(57) ABSTRACT

The present invention relates to network security technology, and particularly relates to a mobile storage device for data processing in security, and a data processing system comprising the mobile storage device, and a data processing method using the data processing system. According to the present invention, the mobile storage device for data processing in security comprising: at least one memory for storing a secret key; an interface circuit; and a processing unit for communicating with a remote device via the interface circuit and performing security processing and application processing, the security processing including data encryption and decryption with the secret key. Compared with the prior art, the mobile storage device according to the embodiments of the present invention stores not only confidential information such as secret key and digital certificate but also applications for executing transaction processes, whereby providing security protection for the applications at the same level as the confidential information. In addition, where the mobile storage device has a capability of simulating a network interface, a client terminal, such as a personal computer, previously used for executing the applications now can function as a bridge connector between the mobile storage device and a remote server, and the packeting and unpacketing of the transaction data can be performed inside the mobile storage device. This greatly improves the security performance of the transaction processes.

### TECHNICAL FIELD

The present invention relates to network security technology, and particularly relates to a mobile storage device for data processing in security, a data processing system including the mobile storage device and a data processing method using the data processing system.

### BACKGROUND ART

E-payment and E-banking are becoming popular in financial sector, but safety has been a major obstacle in its development. In order to deal with this issue, banking industry has a variety of solutions, such as dynamic password, token and key disk or USB disk etc.

Mobile storage device, such as key disk, is one kind of hardware which comprises a physical interface (such as USB interface, SD interface and MMC interface), a microprocessor, memory and chip operating system (COS). User's secret keys and/or digital certificate are stored in a data storage space under protection, which is accessed via dedicated program built in the device. In other words, no one can directly access to the space and the secret keys therein are not exportable. This prevents the possibility of copying the digital certificate or identity information stored therein. In addition, the microprocessor is configured to carry out a variety of algorithms for encryption/decryption and signature, which provide a security mechanism for communication between client and server, for example, authenticating user identity encrypting sensitive data. It shall be noted that in the mobile storage devices based on the existing architecture, the dedicated program inside the device only provides its application program interface (API), which can be called by external applications in a process involved in the secret key or the digital certificate. However, the dedicated program has no association with the external applications in view of application logic.

The prior art cannot substantially prevent hackers from spying on and attacking sensitive data involved in a transaction. Thus, it needs to provide a mechanism to guarantee the security of the transaction.

### SUMMARY OF THE INVENTION

One of the objectives of the present invention is to provide a mobile storage device for data processing in security, which greatly improves the safety of payment services.

In order to achieve the objective, the mobile storage device for data processing in security comprises:

at least one memory for storing a secret key;
an interface circuit; and
a processing unit for communicating with a remote device via the interface circuit and performing security processing and application processing, the security processing including data encryption and decryption with the secret key.

Preferably, in the above-mentioned mobile storage device, the processing unit comprising hardware circuits for performing the security processing and the application processing respectively.

Preferably, in the above-mentioned mobile storage device, the processing unit comprising a microprocessor for performing the security processing and the application processing by executing respective programs.

Preferably, in the above-mentioned mobile storage device, the memory is a flash memory or other electrically erasable memory, the interface circuit is at least one of a USB interface, a SIM card interface, a SD interface, or an MMC interface.

Preferably, in the above-mentioned mobile storage device, the interface circuit simulates a network interface complying with a specific network protocol, enabling the processing unit to communicate with the remote device via a client terminal connected to a network.

Preferably, in the above-mentioned mobile storage device, the program for the application processing is used for implementing online banking business, and the security processing is performed by calling the program for the security processing via application program interface.

Preferably, in the above-mentioned mobile storage device, the program for the application processing establishes a direct network connection to the remote device via the interface circuit simulating the network interface complying with the specific network protocol.

Preferably, in the above-mentioned mobile storage device, the network protocol is a TCP/IP protocol stack.

Preferably, in the above-mentioned mobile storage device, wherein comprising two or more memories for storing the respective programs.

Another objective of the present invention is to provide a data processing system, which greatly improved the security of payment services in network environment.

To achieve the above objective, the data processing system comprises:

at least one server connected to a network;
a mobile storage device, comprising:
at least one memory for storing a secret key;
an interface circuit; and
a processing unit for communicating with the servers via the interface circuit and performing security processing and application processing, the security processing includes data encryption and decryption with the secret key, the application processing includes generating messages which contain data encrypted with aid secret key.

In the above-mentioned data processing system, the mobile storage device is connected with the client terminal in access to the network via the interface circuit, enabling the mobile storage device to access the network for achieving communication between the processing unit and the server.

In the above-mentioned data processing system, the memory is a flash memory or other electrically erasable memory, the interface circuit is at least one of a USB interface, a SIM card interface, a SD interface, or a MMC interface.

In the above-mentioned data processing system, the interface circuit simulates a network interface complying with a specific network protocol, enabling the processing unit to communicate with the servers via a client terminal connected to the network.

Also another objective of the present invention is to provide a method for data processing in security by utilizing the data processing system as stated above, which greatly improves the security of payment services in network environment.

To realize the above objective, the method comprises the steps of:

establishing a network connection between the processing unit and the at least one server via the interface circuit;
the processing unit interacting with the at least one server to execute a transaction process, wherein the processing unit generates a message concerning the transaction process and containing data encrypted by the secret key;
the processing unit sending the message to the at least one server via the network connection; and
the at least one server decrypting the data contained in the message and performing the data processing.

Preferably, in the above-mentioned method, the network connection between the mobile storage device and the at least one server is established in such a manner that the mobile storage device is connected to the client terminal connected to the network via the interface circuit, whereby the mobile storage device is connected to the network via the client terminal.

Compared with the prior art, the mobile storage device according to the embodiments of the present invention stores not only confidential information such as secret key and digital certificate but also applications for executing transaction processes, whereby providing security protection for the applications at the same level as the confidential information. In addition, where the mobile storage device has a capability of simulating a network interface, a client terminal, such as a personal computer, previously used for executing the applications now can function as a bridge connector between the mobile storage device and a remote server, and the packeting and unpacketing of the transaction data can be performed inside the mobile storage device. This greatly improves the security performance of the transaction processes.

### DESCRIPTION ON DRAWINGS

The objectives and advantages of the present invention as described above and elsewhere can be seen more clearly and completely from the following detailed explanations in combination with the figures as attached.

FIG. 1 is a schematic diagram showing architecture of the mobile storage device according to one embodiment of the present invention.

FIGS. 2a and 2b are diagrams respectively showing the physical structure and the logical structure of network connection between the mobile storage device according to another embodiment of the present invention and a remote device.

FIG. 3 is a schematic diagram showing architecture for internal operation performed in the mobile storage device according to one embodiment of the present invention.

FIG. 4 is a schematic diagram showing the data processing system according to another embodiment of the present invention.

FIG. 5 is a flowchart showing the method for achieving data processing in security according to another embodiment of the present invention.

### EMBODIMENTS

The embodiments are described below with reference to the figures.

### I. The Mobile Storage Device

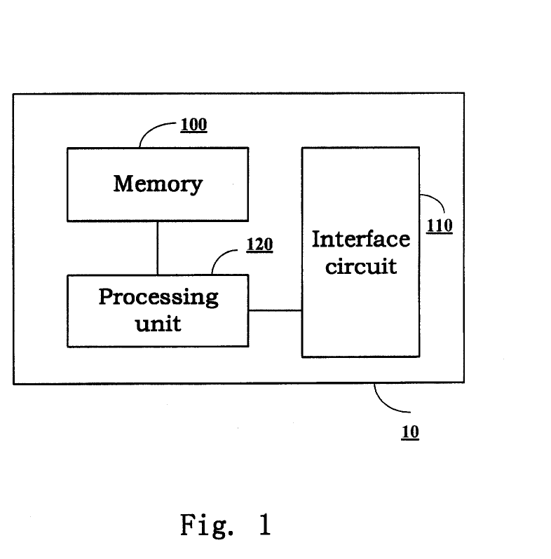

FIG. 1 is a schematic diagram showing architecture of the mobile storage device according to one embodiment of the present invention. In the present embodiment, the mobile storage device is in the form of a key disk. However, it is apparent to the skilled in the art that the principle and concept as embodied herein are also applicable to other kinds of the mobile storage devices, for example, including but not limited to a SIM card, a SD card and a MMC card.

As illustrated in FIG. 1, key disk 10 mainly comprises memory 100, interface circuit 110 and processing unit 120.

Memory 100 may be, for example, read-only memory, flash memory, or other forms of non-volatile memory. It should be noted that in FIG. 1, memory 100 is shown as a block, but this does not mean that only one memory can be arranged in the disk. In fact, two or more memories are also available, and preferably, confidential information, such as secret keys and digital certificates, and applications are stored in different memories. Among them, one for the confidential information is not accessible by external devices, and one for the applications is accessible with restriction. For example, the applications can only be called but can not be rewritten. Alternatively, in the case of one memory, it can be divided into different regions for the confidential information and the applications respectively, and different restriction strategies are applied to these regions. It shall be noted that such modification and change are within the spirit and scope of the present invention.

Interface circuit 110 provides a physical interface for communication between the internal components of the key disk and the external devices. In the present embodiment, for example, interface circuit 110 can be a USB interface, a SD interface, a MMC interface or an RJ45 interface for connecting to a LAN.

Processing unit 120 is the core of key disk 10 and its functions include, for example, security processing and application processing as further described below.

### A. Security Processing

The digital certificate is configured to employ a security mechanism based on asymmetric encryption algorithms such as RSA encryption algorithm, and a certification authority generates a pair of matched keys for a user, i.e. a public key and a private key, among which the former is available from the user's digital certificate and the latter is in secret (e.g., in the present embodiment, it is stored in memory 100 as the confidential information and can not be accessed by the external devices). In typical applications such as e-payment and e-banking, in order to provide secure communication between a sender and a recipient, the sender encrypts plaintext with the recipient's public key to generate cipher text, and the recipient decrypts the cipher text with its private key. Because only the recipient possesses its private key, the communication can be achieved in security. In order to strengthen the security, a mechanism based on SSL protocol can be used, wherein the public keys and the private keys of the sender and recipient remain unchanged, but dynamic session keys are introduced in each session to encrypt messages to be transmitted. This makes it more difficult to decipher the messages and further ensures the security of data transmission. In addition, the security processing can also be based on a symmetric encryption algorithm, wherein the sender and the recipient use the same secret key.

In the present embodiment, the messages from and to the external devices are decrypted and encrypted in processing unit 120. These encryption and decryption processing are both referred to as security processing in the specification.

The security processing can be performed by means of a dedicated hardware circuit as part of processing unit 120. Alternatively, processing unit 120 comprises a general-purpose microprocessor executing a set of instructions for the security processing. In addition, the instructions can be stored in memory 100.

It shall be noted that although the communication between key disk 10 and the external devices is based on an asymmetric encryption algorithm as described above, a security mechanism based on symmetric encryption algorithms is also applicable.

### B. Application Processing

The existing key disk can provide the security processing including encryption and decryption, and the application processing, e.g., associated with the transaction other than the security processing, are mostly performed on the external devices such as a client terminal and a remote server. For example, when an e-banking or e-payment transaction is initiated, application program residing in the client terminal typically performs the following operations:

(1) User Authentication

For example, the application program prompts a user to input his username and password through the client terminal and then judges whether he/she is a valid user. The application program will activate the key disk, making it into an enable state only if the authentication is successful.

(2) Network Connection Establishment

The application program on the client terminal can establish a secure communication channel with the remote server based on SSL protocol by using a digital certificate stored in key disk 10.

(3) Generating and Sending Message

The application program displays a business logic interface to the user, and based on the function selected by the user from the business logic interface, generates a message containing encrypted data and then send it to the remote device. During this operation, the client terminal may call the security processing performed inside the key disk to encrypt sensitive data, for example, including but not limited to merchant code, sub-merchant/terminal code, order number, transaction amount, transaction currency, the amount of debit, debit currency, the exchange rate of the debit, account information, track information, PIN and card expiration date.

(4) Receiving and Analyzing Message

The application programs in the client terminal receives a message from the remote server and displays a business logic interface based on the message. Specifically, the application program calls the security processing performed inside key disk 10, for example to decrypt the received message and extract the data required to generate the business logic interface.

In the present embodiment, the application processing is performed by processing unit 120 inside key disk 10. Compared with the prior art where the application processing is performed by the client terminal, because the sensitive data are provided in encrypted form outside key disk 10 and the operations previously performed at the client terminal now is performed inside key disk 10, the security is greatly improved. In addition, no application program is necessary to be installed on the client terminal.

As well, a dedicated hardware circuit may be arranged in processing unit 120 to perform the application processing. Alternatively, processing unit 120 can comprises a general-purpose microprocessor executing application(s) for the application processing. In addition, the application(s) can also be stored in memory 100.

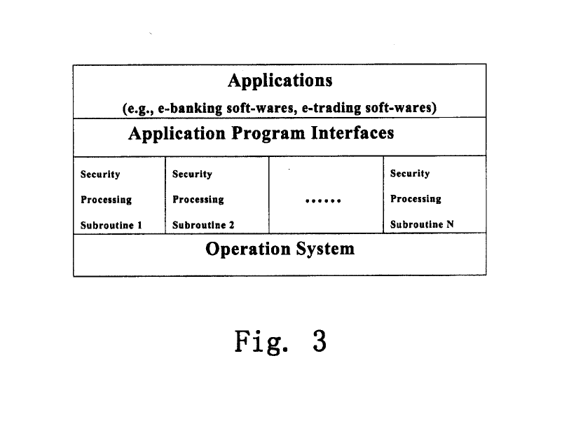

Preferably, as shown in FIG. 3, with application program interface (API), the applications such as e-banking software and e-trading software can call subroutines for the security processing to perform business logic.

To access networks based on different physical media, interface circuit 110 in key disk 10 is configured to function as a corresponding physical interface. Alternatively, in order to provide communication between key disk 10 and a remote device, interface circuit 110 can be an interface such as USB interface, SIM card interface, SD interface or MMC interface, and configured to simulate a network interface complying with specific communication protocol by means of a corresponding driver on the client terminal (e.g., personal computer, personal digital aid or mobile phone).

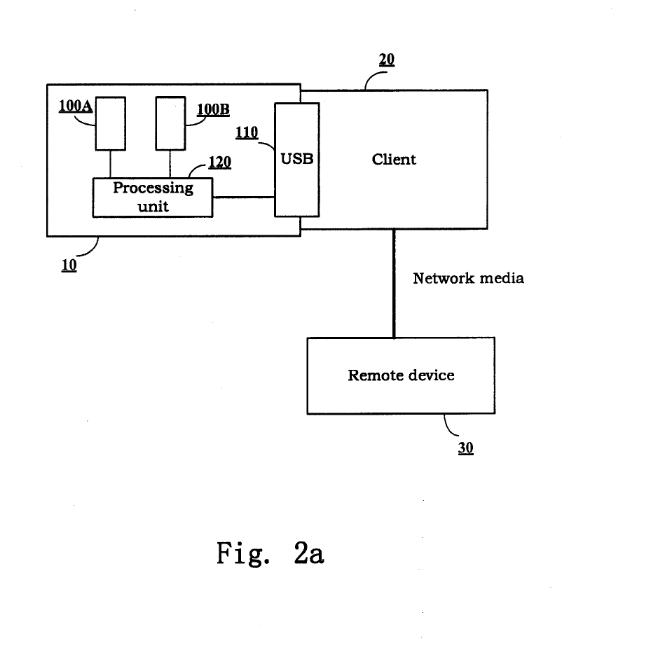

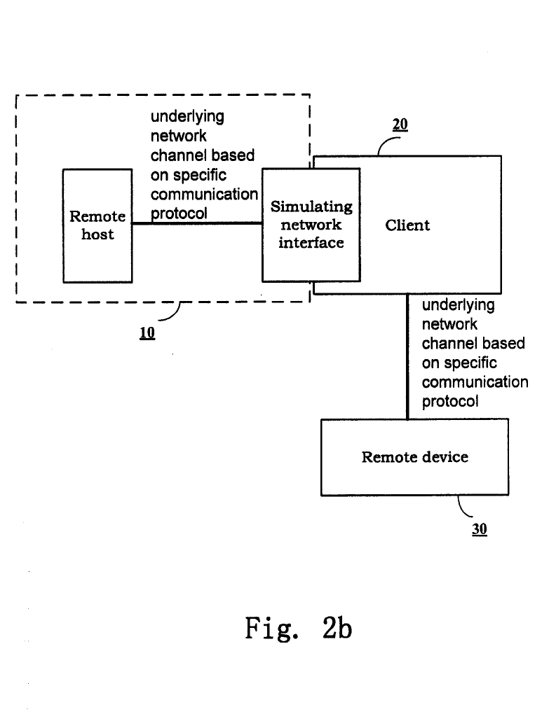

FIGS. 2a and 2b are diagrams respectively showing its physical structure and logical structure of network connection between the mobile storage device according to another embodiment of the present invention and a remote device. In this embodiment, the key disk is exemplified to equipped with USB interface.

As illustrated in FIG. 2a, key disk 10 is connected to client terminal 20 (e.g., a personal computer) through USB interface, and client terminal 20 is connected with remote device 30 (e.g., a remote server) via a network, and key disk 10 comprises interface circuit 110 and processing unit 120. Compared to the arrangement as shown in FIG. 1, the key disk herein comprises memory 100A and memory 100B, wherein confidential information such as the secret key is stored in memory 100A, and programs for the security processing and the application processing (e.g. WEB browser) are stored in memory 100B. Also, memory 100B stores network driver(s) to make the key disk to simulate a virtual network device. The programs stored therein are read-only and prohibited from being replaced or modified.

As shown in FIG. 2b, upon installing the network driver(s) on client terminal 20, its USB interface may simulate a network interface, and key disk 10 connected to client terminal 20 via this simulated network interface is considered as a remote host by client terminal 20. Therefore, client terminal 20 now functions as a bridge for establishing an underlying network channel between key disk 10 and remote device 30, and processing unit 120 can communicate “directly” with remote device 30 through client terminal 20 complying with a specific communication protocols such as TCP/IP network protocol. On the other hand, memory 100B is configured to be a USB storage disc accessible by an external device, whereby on client terminal 20, the network driver(s) can be directly installed and the programs for application processing can be initiated.

### II. Data Processing System

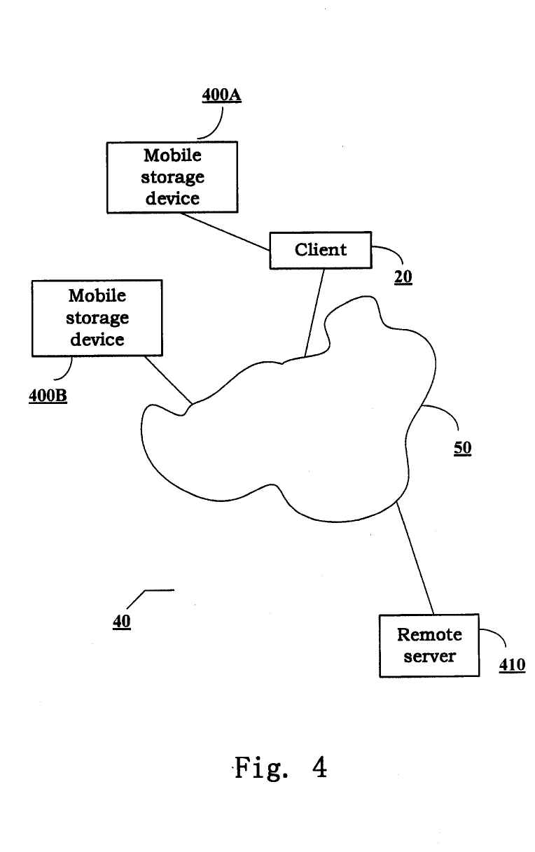

FIG. 4 is a schematic diagram showing the data processing system according to another embodiment of the present invention. For illustrative purpose, this embodiment is described in terms of a client/server distributed architecture for e-payment service.

As illustrated in FIG. 4, data processing system 40 comprises mobile storage devices 400A and 400B and remote server 410. Mobile storage devices 400A and 400B act as clients responsible for security processing and application processing at users side and can be in the form of the key disk having the architecture as shown in FIG. 1. Remote server 410 is configured to perform e-payment handling at bank side.

In FIG. 4, mobile storage device 400A, for example, may be a SIM card installed in client terminal 20 (exemplified as a mobile phone herein), which can be wirelessly connected to Internet 50. Likewise, with network driver(s) installed therein, client terminal 20 acts as a bridge for establishing an underlying network channel between mobile storage devices 400A and remote server 410. Thus, mobile storage device 400A can communicate with remote server 410 in accordance with a specific communication protocol such as TCP/IP network protocol.

Preferably, mobile storage device 400A per se is not equipped with user input device and/or user output device and is configured to communicate with the user via input and output devices of client terminal 20, e.g., keyboard, touch screen, mouse, and display, etc.

Mobile storage device 400B has sufficient hardware resources, and with its input/output devices and network interface, it can be directly connected to network 50 and thus communicate with remote server 410 without client terminal 20.

### III. Data Security Processing Method

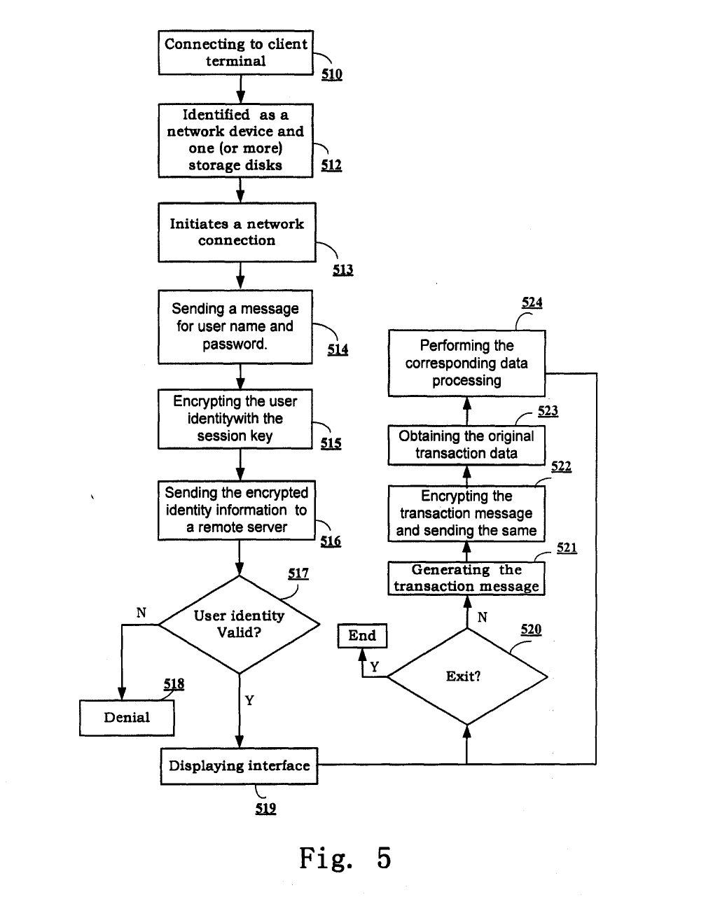

FIG. 5 is a flowchart showing the method for achieving data processing in security according to another embodiment of the present invention. The method of the present embodiment is carried out by means of the data processing system as shown in FIG. 4.

As illustrated in FIG. 5, at step 510, mobile storage device 400 is connected to client terminal 20. With respect to USB key disk, the connection is performed by inserting the key disk into the USB interface of a client terminal. For SIM card, it is connected to the client terminal after being installed into a mobile phone.

Then the flow proceeds to step 511, where mobile storage device 400 is identified by client terminal 20 as a network device and one (or more) storage disks, as described above in conjunction with FIGS. 2a and 2b.

Then the flow proceeds to step 513, where the processing unit in mobile storage device 400 initiates a network connection to remote server 410 via network 50. For example, a user can establish the network connection by the following way: initiating an application program (such as WEB browser) stored in memory of mobile storage device 400 or in client terminal 20 via input devices such as keyboard, mouse or touch screen, and entering the address of remote server 410 in the Web browser's address bar on the interface of the application program displayed on the output devices such as the display of client terminal 20. Since the client terminal has been connected to network 50, the processing unit can thus establish a network connection with remote server 410 and send a public key (e.g., in the form of a digital certificate) to remote server 410. Optionally, the address of remote server 410 may be built-in the application program in mobile storage device 400, so that the user has no need to manually enter the address of the remote server.

Then the flow proceeds to step 514, where remote server 410 sends a message to mobile storage device 400 for inputting user name and password. The message includes a session key encrypted with the user's public key.

Then the flow proceeds to step 515, where the processing unit of mobile storage devices 400 obtains the session key from the message by using the user's private key, and then uses the session key to encrypt the username and password input by the user through the keyboard, mouse or touch screen on client terminal 20.

Next, at step 516, the processing unit sends the identity information encrypted with the session key to a remote server 410 via the established network connection for authenticating the user's identity.

At step 517, remote server 410 decrypts the username and password with the session key and judges whether the user identity is valid. If it is invalid, the flow proceeds to step 518, where denial information is returned to the user; otherwise, the flow proceeds to step 519, where an interface for data processing is displayed on client terminal 20.

At step 520, by using keyboard, mouse or touch screen, the user selects an Exit option on the interface or selects another option for specific data processing function, e.g., bank account transfer.

If the Exit option is selected, then the flow terminates; otherwise the flow proceeds to step 521. At step 521, the selection associated with the specific data processing function is reported to the processing unit in mobile storage device 400. As a response, the processing unit generates relevant transaction data, for example, including the amount of the transaction, the transaction currency, the amount of the debit, the debit account currency and the debit exchange rates, among which, the sensitive data is first encrypted by the processing unit with the user's private key stored in the memory of mobile storage devices 400, is further encrypted by the processing unit with the public key assigned to remote server 410, and then is encapsulated into a transaction message.

At step 522, the processing unit encrypts the transaction message with the session key, and then transmits it to remote server 410 via the established network connection.

At step 523, remote server 410 first decrypts the transaction message by using the session key, and then decrypts the encrypted data contained in the transaction message with the user's public key, and finally decrypts it with the private key assigned to remote server 410 to obtain the transaction data.

At step 524, remote server 410 performs the corresponding data processing to complete the transaction requested by the user, e.g., bank account transfer, and then the flow returns to step 520.

The present invention can be implemented in various forms without departing from the basic spirit of the present invention, therefore, the specific embodiments described above are only illustrative but not restrictive. The scope of the present invention is defined by the appended claims, any changes or variations to the above descriptions belong to the scope of protection of the appended claims.

1. A mobile storage device for data processing in security, comprising
at least one memory for storing a secret key;
an interface circuit; and
a processing unit for communicating with a remote device via the interface circuit and performing security processing and application processing, the security processing including data encryption and decryption with the secret key.

2. The mobile storage device according to claim 1, wherein the processing unit comprising hardware circuits for performing the security processing and the application processing respectively.

3. The mobile storage device according to claim 1, wherein the processing unit comprising a microprocessor for performing the security processing and the application processing by executing respective programs.

4. The mobile storage device according to claim 1 or 2, wherein the memory is a flash memory or other electrically erasable memory, the interface circuit is at least one of a USB interface, a SIM card interface, a SD interface, or an MMC interface.

5. The mobile storage device according to claim 1 or 2, wherein the interface circuit simulates a network interface complying with a specific network protocol, enabling the processing unit to communicate with the remote device via a client terminal connected to a network.

6. The mobile storage device according to claim 3, wherein the program for the application processing is used for implementing e-banking business, and the security processing is performed by calling the program for the security processing via application program interface.

7. The mobile storage device according to claim 5, wherein the program for the application processing establishes a direct network connection to the remote device via the interface circuit simulating as the network interface complying with the specific network protocol.

8. The mobile storage device according to claim 5, wherein the network protocol is a TCP/IP protocol stack.

9. The mobile storage device according to claim 3, wherein comprising two or more memories for storing the respective programs.

10. A data processing system comprising:
at least one server connected to a network;
a mobile storage device, comprising:
at least one memory for storing a secret key;
an interface circuit; and
a processing unit for communicating with the servers via the interface circuit and performing security processing and application processing, the security processing includes data encryption and decryption with the secret key, the application processing includes generating messages which contain data encrypted with aid secret key.

11. The data processing system according to claim 10, wherein the interface circuit simulates a network interface complying with a specific network protocol, enabling the processing unit to communicate with the servers via a client terminal connected to the network.

12. The data processing system according to claim 10, wherein the memory is a flash memory or other electrically erasable memory, the interface circuit is at least one of a USB interface, a SIM card interface, a SD interface, or a MMC interface.

13. The data processing system according to claim 11, wherein the processing unit comprising a microprocessor for performing the security processing and the application processing by executing respective programs.

14. The data processing system according to claim 13, wherein the program for the application processing is used for implementing e-banking business, and the security processing is performed by calling the program for the security processing via application program interface.

15. The data processing system according to claim 13, wherein the program for the application processing establishes a direct network connection to the remote device via the interface circuit simulating as the network interface complying with the specific network protocol.

16. The data processing system according to claim 15, wherein the network protocol is a TCP/IP protocol stack.

17. The data processing system according to claim 10, wherein comprising two or more memories for storing the respective programs.

18. A method for data processing in security by utilizing the data processing system according to anyone of claims 10-17, comprising the steps of:
establishing a network connection between the processing unit and the at least one server via the interface circuit;
the processing unit interacting with the at least one server to execute a transaction process, wherein the processing unit generates a message concerning the transaction process and containing data encrypted by the secret key;
the processing unit sending the message to the at least one server via the network connection; and
the at least one server decrypting the data contained in the message and performing the data processing.

19. The method according to claim 18, wherein the network connection between the mobile storage device and the at least one server is established in such a manner that the mobile storage device is connected to the client terminal connected to the network via the interface circuit, whereby the mobile storage device is connected to the network via the client terminal.
